(19) United States
(12) Patent Application Publication
(10) Pub. No.: US 2015/0304061 A1
(43) Pub. Date: Oct. 22, 2015

(54) SYNCHRONIZATION AT A RADIO LINK CONTROL (RLC) LAYER ENTITY

(71) Applicant: QUALCOMM Incorporated, San Diego, CA (US)

(72) Inventors: Vagish Gupta, Hyderabad (IN); Sitaramanjaneyulu Kanamarlapudi, San Diego, CA (US); Abhinav Gupta, San Jose, CA (US)

(21) Appl. No.: 14/452,319

(22) Filed: Aug. 5, 2014

Related U.S. Application Data
(60) Provisional application No. 61/982,076, filed on Apr. 21, 2014.

(51) Int. Cl. H04J 3/06

(52) U.S. Cl. CPC H04J 3/0658

(57) ABSTRACT

Aspects are described for synchronizing a user equipment (UE) and at least one network entity at, for example, a Radio Link Control (RLC) layer entity. The aspects may include receiving a first status packet data unit (PDU). In some aspects, the first status PDU may be a most recent non-erroneous status PDU. Further, the aspects may include receiving a second status PDU. In some aspects, the second status PDU may be received subsequent to receiving the first status PDU. Moreover, the aspects may include determining whether the first status PDU and the second status PDU are transmitted from a same network entity. Additionally, the aspects may include performing a RLC reset based at least in part on a determination being made that the first status PDU and the second status PDU are transmitted from the same network entity.

### CLAIM OF PRIORITY

The present application for patent claims priority to Provisional Application No. 61/982,076 entitled “METHOD AND APPARATUS FOR SYNCHRONIZATION AT A RADIO LINK CONTROL (RLC) LAYER” filed Apr. 21, 2014, which is assigned to the assignee hereof and hereby expressly incorporated by reference herein.

### BACKGROUND

Aspects of the present disclosure relate generally to wireless communication systems, and more particularly, to synchronizing a user equipment (UE) and a network entity at, for example, an radio link control (RLC) layer entity.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In some wireless communication networks, inefficient and/or ineffective utilization of available communication resources, particularly out-of-sync communication on the uplink and/or downlink may lead to degradations in wireless communication. Even more, the foregoing inefficient resource utilization inhibits user equipments and/or wireless devices from achieving higher wireless communication quality. Thus, improvements in synchronization in communication networks are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method for synchronizing a user equipment (UE) and at least one network entity at the Radio Link Control (RLC) layer includes receiving a first status packet data unit (PDU), wherein the first status PDU is the most recent non-erroneous status PDU. Further, the method includes receiving a second status PDU, wherein the second status PDU is received subsequent to receiving the first status PDU. Moreover, the method includes identifying that the second status PDU includes an erroneous sequence number (SN) based at least in part on the first status PDU. Additionally, the method includes determining whether to perform a Radio Link Control (RLC) reset based at least in part on determining that the second status PDU includes the erroneous SN.

In another aspect, a computer-readable medium storing computer executable code for synchronization in a communication network, including code executable to receive a first status packet data unit (PDU), wherein the first status PDU is the most recent non-erroneous status PDU. The computer-readable medium further includes code executable to receive a second status PDU, wherein the second status PDU is received subsequent to receiving the first status PDU. Additionally, the computer-readable medium includes code executable to identify that the second status PDU includes an erroneous sequence number (SN) based at least in part on the first status PDU. Moreover, the computer-readable medium includes code executable to determine whether to perform a Radio Link Control (RLC) reset based at least in part on determining that the second status PDU includes the erroneous SN.

In a further aspect, an apparatus for synchronization in a communication network includes means for receiving a first status packet data unit (PDU), wherein the first status PDU is the a most recent non-erroneous status PDU. The apparatus further includes means for receiving a second status PDU, wherein the second status PDU is received subsequent to receiving the first status PDU. In addition, the apparatus includes means for identifying that the second status PDU includes an erroneous sequence number (SN) based at least in part on the first status PDU. Moreover, the apparatus includes means for determining whether to perform a Radio Link Control (RLC) reset based at least in part on determining that the second status PDU includes the erroneous SN.

In an additional aspect, an apparatus for synchronization in a communication network includes a communication component configured to receive a first status packet data unit (PDU), wherein the first status PDU is the most recent non-erroneous status PDU. Further, the communication component is further configured to receive a second status PDU, wherein the second status PDU is received subsequent to receiving the first status PDU. Additionally, the apparatus includes an identification component configured to identify that the second status PDU includes an erroneous sequence number (SN) based at least in part on the first status PDU. Moreover, the apparatus includes an radio link control (RLC) reset determination component configured to determine whether to perform a Radio Link Control (RLC) reset based at least in part on determining that the second status PDU includes the erroneous SN.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings, in which like reference characters identify like subject matter throughout, where a dashed line may indicate an optional component or action, and wherein:

FIG. 1 is a schematic diagram illustrating an including an aspect of a UE that may determine whether to perform an RLC reset according to the synchronization component;

FIG. 2 is a flow diagram illustrating an example method in a wireless communication system in accordance with an aspect of the present disclosure, e.g., according to FIG. 1;

FIG. 3 is a flow diagram illustrating another example method in a wireless communication system in accordance with an aspect of the present disclosure, e.g., according to FIG. 1;

FIG. 4 is a block diagram illustrating an example of a hardware implementation for an apparatus employing a processing system in accordance with an aspect of the present disclosure, e.g., according to FIG. 1;

FIG. 5 is a block diagram conceptually illustrating an example of a telecommunications system in accordance with an aspect of the present disclosure, e.g., according to FIG. 1;

FIG. 6 is a conceptual diagram illustrating an example of an access network in accordance with an aspect of the present disclosure, e.g., according to FIG. 1;

FIG. 7 is a conceptual diagram illustrating an example of a radio protocol architecture for the user and control plane in accordance with an aspect of the present disclosure, e.g., according to FIG. 1; and

FIG. 8 is a block diagram conceptually illustrating an example of a Node B in communication with a UE in a telecommunications system in accordance with an aspect of the present disclosure, e.g., according to FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to synchronizing a UE and at least one network entity in a wireless communication network. Specifically, there may be a possibility that downlink status packet data units (PDUs) sent to the UE by a network entity may not reach the UE in the same order when they were sent to two physically separated (or otherwise separate) network entities to be subsequently transferred to UE. For example, in a non-limiting aspect, a UE may transmit PDUs with sequence numbers (SN) from 0 to 100 to a network entity. In response, the network may transmit status PDU with requests for retransmission of PDUs with SNs of 5, 10, and 15, and acknowledge (ACK) up to SN of 20. The UE may then retransmit PDUs with SNs of 5, 10, and 15 in response to the status PDU. Before the retransmitted PDUs are received by the network, the network may transmit another status PDU for request for retransmission of PDUs with SNs of 5, 10, and 15 on a different flow, from another network entity (NodeB), which has been running slow possibly due to Hybrid Automatic Repeat Request (HARQ) retransmissions or scheduling delays.

The retransmitted PDUs with SNs of 5, 10, and 15 may be received by the network, which in turn transmits status PDU with ACKing PDUs up to SN 101. This triggers the UE to move the SN to 101 meaning that the UE expects to receive status PDU with SN of 101. However, the UE may receive the second status PDU now from another Node B, which may be running slow relative to normal operation. This may result in the case of an erroneous SN in status PDU such that a status PDU indicating a negative acknowledgment (NACK) of one or more PDUs is received at a UE following an indication (ACK) of the same PDUs previously indicated as properly received by the network entity.

As such, if an acknowledged mode (AM) RLC entity (e.g., at the UE) receives a status PDU including an erroneous SN, it (e.g., the UE) may be configured to discard the status PDU, and if inter-Node B multi-flow operation is not currently configured, then the UE may initiate the RLC reset procedure. However, this arrangement sacrifices the functionality, in inter-Node B multi-flow configurations, where no corrective action is taken even when the UE and the network are out-of-sync and receiving erroneous status PDUs.

Accordingly, in some aspects, the present methods and apparatuses may provide an efficient solution, as compared to current solutions, by synchronizing a UE and at least one network entity in a wireless communication system and hence be able to discard the status PDUs with erroneous sequence number selectively in one case while accept and perform the corrective action in other case.

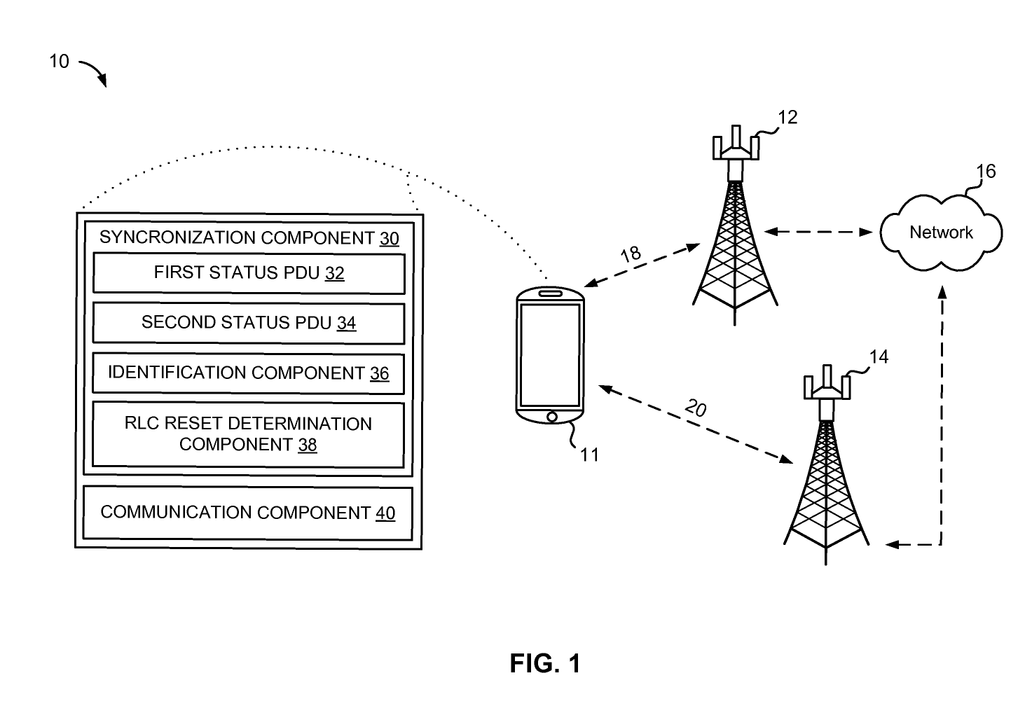

Referring to FIG. 1, in one aspect, a wireless communication system 10 is configured to facilitate synchronization of a UE and at least one network entity at an RLC layer entity. Wireless communication system 10 includes at least one UE 11 that may communicate wirelessly with one or more networks (e.g., network 16) via one or more network entities, including, but not limited to, first network entity 12 and/or second network entity 14. For example, UE 11 may communicate with one or more cells included or deployed at one or both first network entity 12 and second network entity 14. In an aspect, first network entity 12 may alternatively be referred to as a first cell with which UE 11 maintains a communication session (e.g., RRC connected state). In another aspect, second network entity 14 may alternatively be referred to as a second cell with which UE 11 maintains a communication session (e.g., RRC connected state).

Further, UE 11 may communicate with network 16 via first network entity 12 and/or second network entity 14. For example, in an aspect, first and second network entities 12 and 14, respectively, may be configured to transmit and receive one or more signals (e.g., packet/protocol data units (PDUs)) via one or more communication channels 18 and/or 20, respectively, to/from UE 11. For instance, one or more signals may be a first status PDU 32 and a second status PDU 34 transmitted from one or both of first network entity 12 and second network entity 14.

In some aspects, first status PDU 32 and second status PDU 34 may include information regarding successes (e.g., ACK) and/or failures (e.g., NACK) of all previous PDUs (e.g., transmitted PDU by UE 11 to a network entity) in the RLC window. An ACK may indicate or signify an acknowledgment or confirmation of a reception of the transmitted one or more PDUs. On the other hand, a negative acknowledgment (NACK) may indicate or signify that at least one transmitted PDU was not received. Furthermore, the physical channels (e.g., frequencies and/or Primary Scrambling Code (PSC) combinations) for each communication channel (e.g., one or more communication channels 18 and/or 20) may be different. As such, UE 11 may be configured to determine which communication channel (e.g., communication channels 18 and/or 20), and as a result, which network entity (e.g., first network entity 12 and/or second network entity 14) each status PDU is received from.

In such aspects, the PSC may assist in detecting the Primary Common Control Physical Channel (P-CCPCH) used for obtaining system and cell specific Broadcast Control Channel (BCH) information. Additionally, a status PDU may be transmitted to inform the sender RLC entity (e.g., UE 11) the acknowledgment information of the RLC AM (Acknowledge Mode) PDUs received at first network entity 12 or second network entity 14. For example, based on the information, the UE 11 may determine to retransmit the negative acknowledged PDUs or to move its transmission window forward.

According to the present aspects, UE 11 may include a synchronization component 30, which may be configured to synchronize UE 11 and at least one network entity (e.g., first network entity 12 and/or second network entity 14) at a protocol layer entity such as, but not limited to, an RLC layer entity in wireless communication system 10. Specifically, in an aspect, synchronization component 30 of UE 11 may be configured to receive, via communication component 40, a first status PDU 32. In some aspects, the first status PDU 32 may be a most recent non-erroneous status PDU. Further, synchronization component 30 may be configured to receive, via communication component 40, a second status PDU 34. In such aspects, the second status PDU 34 may be received subsequent to receiving the first status PDU 32. In some instances, second status PDU 34 may be any PDU received after receiving first status PDU 32.

As such, synchronization component 30 may include identification component 36, which may be configured to identify that the second status PDU 34 includes an erroneous sequence number based on, for example, first status PDU 32. An erroneous PDU (e.g., erroneous status PDU) may be one which carries an erroneous sequence number. Specifically, a status PDU including an erroneous sequence number may be a status PDU that includes a list, bitmap or Relative List (RLIST) Super Field (SUFI) in which the sequence number of at least one AMD PDU that is NACKed is outside the interval VT(A)<=sequence number<VT(S), where VT(A) may be an acknowledgment state variable and VT(S) may be a send state variable. Additionally, the status PDU including an erroneous sequence number may be an ACK SUFI in which last sequence number (LSN) is outside the interval VT(A)<=LSN<VT(S).

In an aspect, to identify that the second status PDU 34 includes the erroneous SN, the identification component 36 may be configured to identify an SN of the first status PDU 32 and an SN of the second status PDU 34. The identification component 36 may further be configured to determine that the SN of the second status PDU 34 is outside an SN interval range. In other words, the identification component 36 may be configured to determine whether the SN of the second status PDU 34 is less than (or equal to) a minimum value of an SN interval range or greater than (or equal to) a maximum value of the SN interval range. In some aspects, the SN interval range may be determined based on the SN of the first status PDU 32.

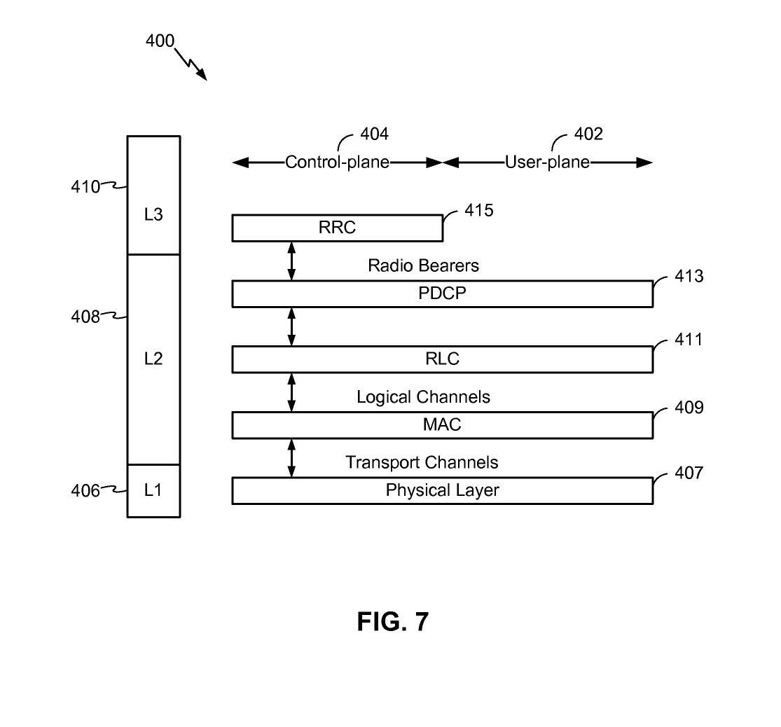

Further, synchronization component 30 may include RLC reset determination component 38, which may be configured to determine whether the first status PDU 32 and the second status PDU 34 are transmitted from a same network entity (e.g., first network entity 12). Further, RLC reset determination component 38 may be configured to perform an RLC reset based at least in part on determining that the first status PDU 32 and the second status PDU 34 are transmitted from the same network entity (e.g., first network entity 12). In some aspects, determining that the first status PDU 32 and the second status PDU 34 are transmitted from the same network entity (e.g., either from first network entity 12 or second network entity 14) may be based at least in part on information extracted or obtained from the first status PDU 32 and the second status PDU 34. Performing the RLC reset may cause the RLC entities within UE 11 (e.g., RLC sublayer 411 in FIG. 7) and the network to bring the peer RLC entities in-sync.

Moreover, RLC reset determination component 38 may be configured to determine that the first status PDU 32 is transmitted from first network entity 12 and the second status PDU 34 is transmitted from second network entity 14. In addition, RLC reset determination component 38 may be configured to determine that first network entity 12 and second network entity 14 are synchronized and to perform the RLC reset in response to determining that first network entity 12 and second network entity 14 are synchronized. In some aspects, synchronization component 30 may be configured to not perform the RLC reset in response to determining that first network entity 12 and second network entity 14 are unsynchronized. The RLC reset determination component 38 may further be configured to detect or identify when first network entity 12 and second network entity 14 are out of synch or unsynchronized based at least in part of the contents and/or timing information (e.g., arrival time) of the first status PDU 32 and the second status PDU 34.

In an aspect, both first and second network entities 12 and 14, respectively, may be synchronized and in case UE 11 is aware of the synchronization, it may perform an RLC reset on receiving erroneous Status PDU from either first network entity 12 and/or second network entity 14 irrespective of which network entity a previous non-erroneous or erroneous PDU is received. As such, this situation may be similar to UE 11 working in non multi-flow configuration.

Moreover, in an alternative or additional aspect, UE 11 may include communication component 40, which may be configured to facilitate or otherwise enable UE 11 to communicate with one or both of first network entity 12 via one or more communication channels 18 according to or utilizing one or more radio access technologies (RATs), and second network entity 14 via one or more communication channels 20 according to or utilizing one or more RATs. In such aspects, the one or more communication channels 18 and 20 may enable communication on both the uplink and downlink between UE 11 and first network entity 12 and/or second network entity 14, respectively.

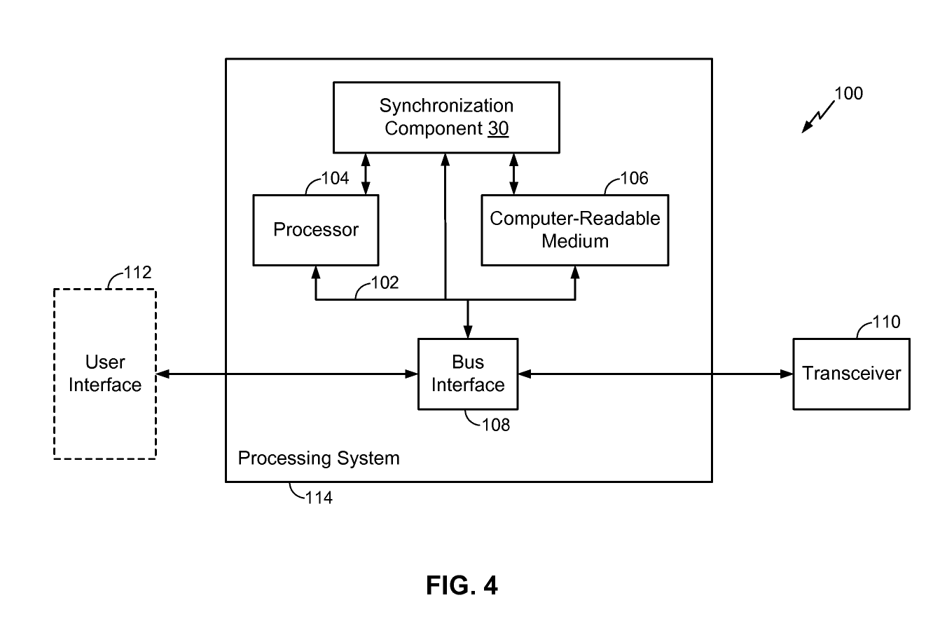

In some aspects, communication component 40 may be configured to receive Status PDUs (e.g., first status PDU 32 and second status PDU 34) from one or both of first network entity 12 and second network entity 14. Additionally, communication component 40 may include a bus or other links to enable communication between the components of UE 11 and/or synchronization component 30. In an example, aspects of the communication component 40 may be performed or implemented by a transmitter, receiver, and/or transceiver (e.g., same or similar to transceiver 110, FIG. 4) in UE 11.

UE 11 may include a mobile apparatus and/or may be referred to as such throughout the present disclosure. Such a mobile apparatus or UE 11 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, a device for Internet-of-Things, or some other suitable terminology.

Additionally, the one or more wireless nodes, including, but not limited to, first and second network entities 12 and/or 14, respectively, of wireless communication system 10, may include one or more of any type of network component, such as an access point, including a base station or node B, a relay, a peer-to-peer device, an authentication, authorization and accounting (AAA) server, a mobile switching center (MSC), a radio network controller (RNC), etc. In a further aspect, the one or more wireless serving nodes of wireless communication system 10 may include one or more small cell base stations, such as, but not limited to a small cell, femtocell, picocell, microcell, or any other base station having a relatively small transmit power or relatively small coverage area as compared to a macro base station.

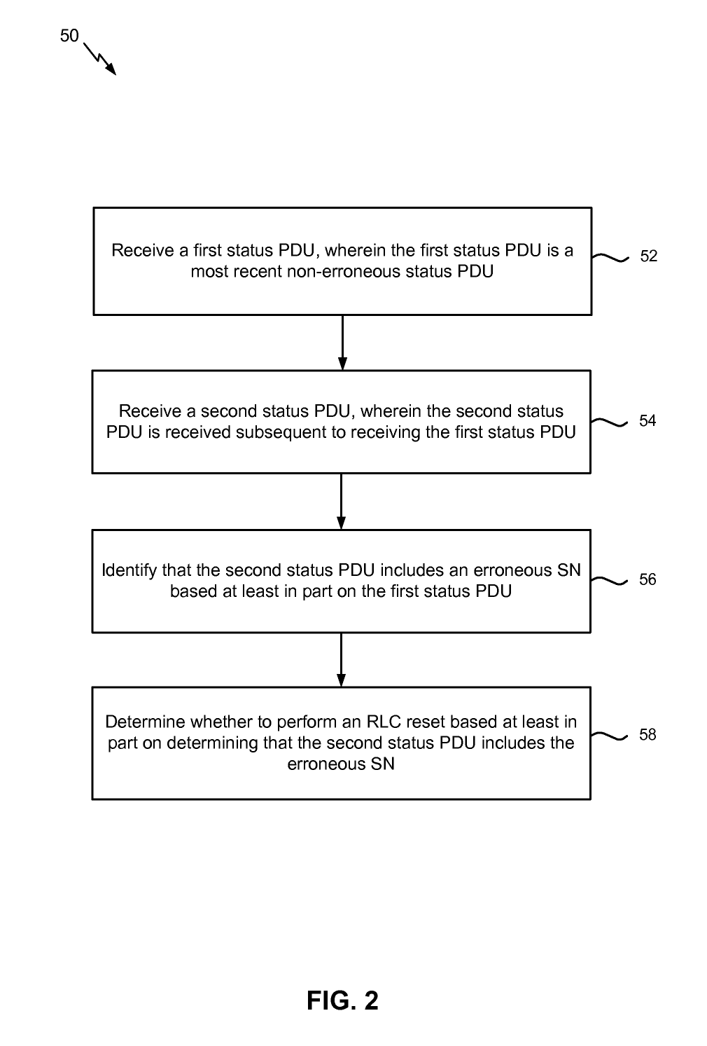

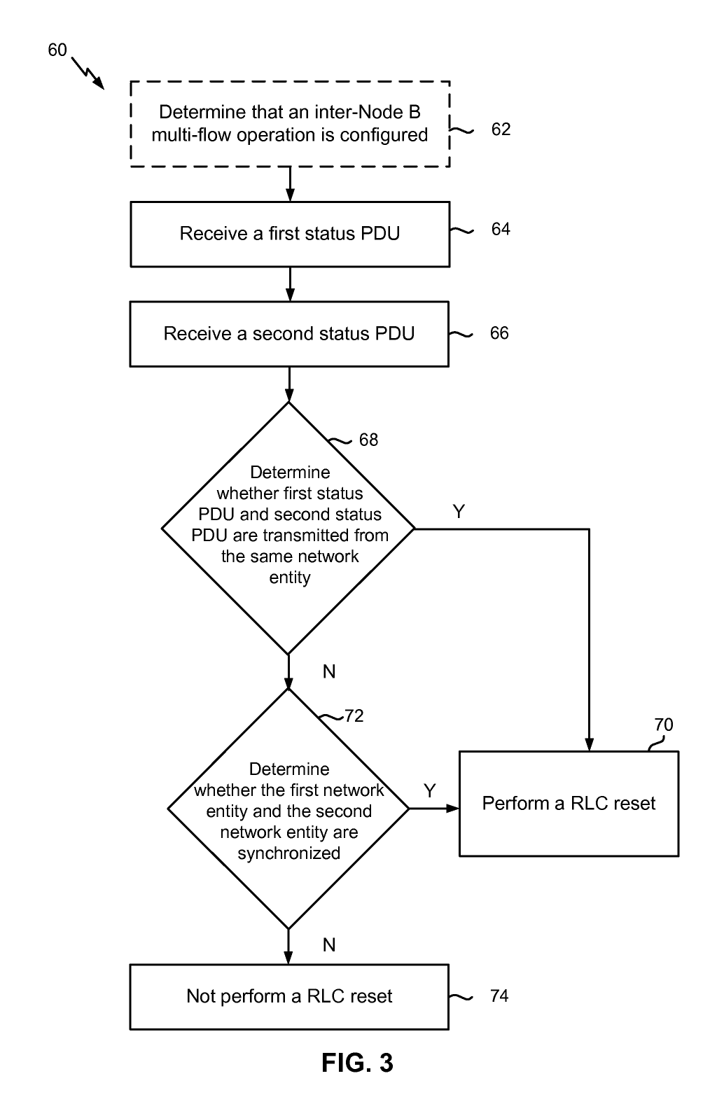

Referring to FIGS. 2 and 3, the methods are shown and described as a series of acts for purposes of simplicity of explanation. However, it is to be understood and appreciated that the methods (and further methods related thereto) are not limited by the order of acts, as some acts may, in accordance with one or more aspects, occur in different orders and/or concurrently with other acts from that shown and described herein. For example, it is to be appreciated that the methods may alternatively be represented as a series of interrelated states or events, such as in a state diagram. Moreover, not all illustrated acts may be required to implement a method in accordance with one or more features described herein.

Referring to FIG. 2, in an operational aspect, a UE such as UE 11 (FIG. 1) may perform one aspect of a method 50 for synchronizing a UE and a network entity at the RLC layer.

In an aspect, at block 52, method 50 may include receiving a first status PDU, wherein the first status PDU is the most recent non-erroneous status PDU. For example, as described herein, UE 11 (FIG. 1) may execute synchronization component 30 (FIG. 1) and/or communication component 40 (FIG. 1) to receive a first status PDU 32 (FIG. 1), wherein the first status PDU 32 (FIG. 1) is the most recent non-erroneous status PDU. In certain aspects, the first status PDU 32 (FIG. 1) may be received via communication channels 18 (FIG. 1) from first network entity 12 (FIG. 1).

At block 54, method 50 may include receiving a second status PDU, wherein the second status PDU is received subsequent to receiving the first status PDU. For example, as described herein, UE 11 (FIG. 1) may execute synchronization component 30 (FIG. 1) and/or communication component 40 (FIG. 1) to receive a second status PDU 34 (FIG. 1), wherein the second status PDU 34 (FIG. 1) is received subsequent to receiving the first status PDU 32 (FIG. 1). In certain instances, the second status PDU 34 (FIG. 1) may be received via communication channels 18 (FIG. 1) from first network entity 12 (FIG. 1). In other instances, the second status PDU 34 (FIG. 1) may be received via communication channels 20 (FIG. 1) from second network entity 14 (FIG. 1).

Further, at block 56, method 50 may include identifying that the second status PDU includes an erroneous SN based at least in part on the first status PDU. For example, as described herein, UE 11 (FIG. 1) and/or synchronization component 30 may execute identification component 36 (FIG. 1) to identify that the second status PDU 34 (FIG. 1) includes an erroneous SN based at least in part on the first status PDU 32 (FIG. 1). In some instances, determining that the first status PDU 32 (FIG. 1) and the second status PDU 34 (FIG. 1) are transmitted from the same network entity (e.g., either from first network entity 12 (FIG. 1) or second network entity 14 (FIG. 1)) is based at least in part on information extracted or obtained from the first status PDU 32 (FIG. 1) and the second status PDU 34 (FIG. 1).

Subsequently, at block 58, method 50 may include determining whether to perform a RLC reset based at least in part on determining that the second status PDU includes the erroneous SN. For example, as described herein, UE 11 (FIG. 1) and/or synchronization component 30 (FIG. 1) may execute RLC reset determination component 38 (FIG. 1) to determine whether to perform a RLC reset based at least in part on determining that the second status PDU 34 (FIG. 1) includes the erroneous SN.

Referring to FIG. 3, in an additional and/or alternate operational aspect, a UE such as UE 11 (FIG. 1) may perform one aspect of a method 60 for synchronizing a UE and one or more network entities at the RLC layer. It should be understood that any one or more of the various component and/or subcomponents of synchronization component 30 (FIG. 1) may be executed to perform the aspects described herein with respect to each block forming method 60.

In an aspect, at block 62, method 60 may optionally include determining that an inter-Node B multi-flow operation is configured. For example, as described herein, UE 11 (FIG. 1) may execute synchronization component 30 to determine that an inter-Node B multi-flow operation is configured. In some instances, receiving the first status PDU 32 comprises receiving the first status PDU 32 when a UE (e.g., UE 11) is configured for an inter-Node B multi-flow operation, and wherein receiving the second status PDU 34 comprises receiving the second status PDU 34 when the UE (e.g., UE 11) is configured for the inter-Node B multi-flow operation.

At block 64, method 60 may include receiving a first status PDU. For example, as described herein, UE 11 (FIG. 1) may execute synchronization component 30 and/or communication component 40 (FIG. 1) to receiving a first status PDU 32. In certain instances, the first status PDU 32 may be received via communication channels 18 from first network entity 12. In an aspect, synchronization component 30 may receive a first status PDU 32, wherein the first status PDU 32 is the most recent non-erroneous status PDU.

At block 66, method 60 may include receiving a second status PDU. For example, as described herein, UE 11 (FIG. 1) may execute synchronization component 30 and/or communication component 40 to receive a second status PDU 34. In certain instances, the second status PDU 34 may be received via communication channels 18 from first network entity 12. In other instances, the second status PDU 34 may be received via communication channels 20 from second network entity 14. Moreover, the second status PDU 34 may be received by UE 11 and/or synchronization component 30 subsequent to receiving the first status PDU 32. In an aspect, synchronization component 30 may identify that the second status PDU 34 includes an erroneous SN based at least in part on the first status PDU 32.

Further, at block 68, method 60 may include determining whether the first status PDU and the second status PDU are transmitted from the same network entity. For example, as described herein, UE 11 (FIG. 1) and/or synchronization component 30 may execute RLC reset determination component 38 to determine whether the first status PDU 32 and the second status PDU 34 are transmitted from the same network entity (e.g., either from first network entity 12 or second network entity 14). If it is determined that the first status PDU 32 and the second status PDU 34 are transmitted from the same network entity, then method 60 may proceed to block 70.

At block 70, method 60 may include performing a RLC reset. For example, as described herein, UE 11 (FIG. 1) may execute synchronization component 30 and/or RLC reset determination component 38 to perform a RLC reset based at least in part on determining that the first status PDU 32 and the second status PDU 34 are transmitted from a same network entity (e.g., from first network entity 12).

Moreover, if it determined that the first status PDU 32 and the second status PDU 34 are transmitted from different network entities (e.g., from first network entity 12 and second network entity 14), then method 60 may proceed to block 72. At block 72, method 60 may include determining whether the first network entity and the second network entity are synchronized. For example, as described herein, UE 11 (FIG. 1) and/or synchronization component 30 may execute RLC reset determination component 38 to determine whether the first network entity 12 and the second network entity 14 are synchronized. If it is determined that the first network entity 12 and the second network entity 14 are synchronized, then method 60 may proceed to block 70 where UE 11 (FIG. 1) may execute synchronization component 30 to perform a RLC reset. However, if it is determined that the first network entity 12 and the second network entity 14 are unsynchronized then method 60 may proceed to block 74.

At block 74, method 60 may include not performing a RLC reset. For example, as described herein, UE 11 (FIG. 1) may execute synchronization component 30 to not perform an RLC reset.

FIG. 4 is a block diagram illustrating an example of a hardware implementation for an apparatus 100 employing a processing system 114, where apparatus 100 may be UE 11 (FIG. 1) or may be included within UE 11, and where apparatus 100 is configured with synchronization component 30 for performing the actions described herein. For example, synchronization component 30 may be implemented as one or more processor modules within processor 104, or as code or instructions stored as computer readable medium 106 and executed by processor 104, or come combination of both. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106.

The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software. The synchronization component 30 may be a part of processor 104 and/or computer-readable medium 106.

The various concepts presented throughout this disclosure may be implemented across a broad variety of telecommunication systems, network architectures, and communication standards.

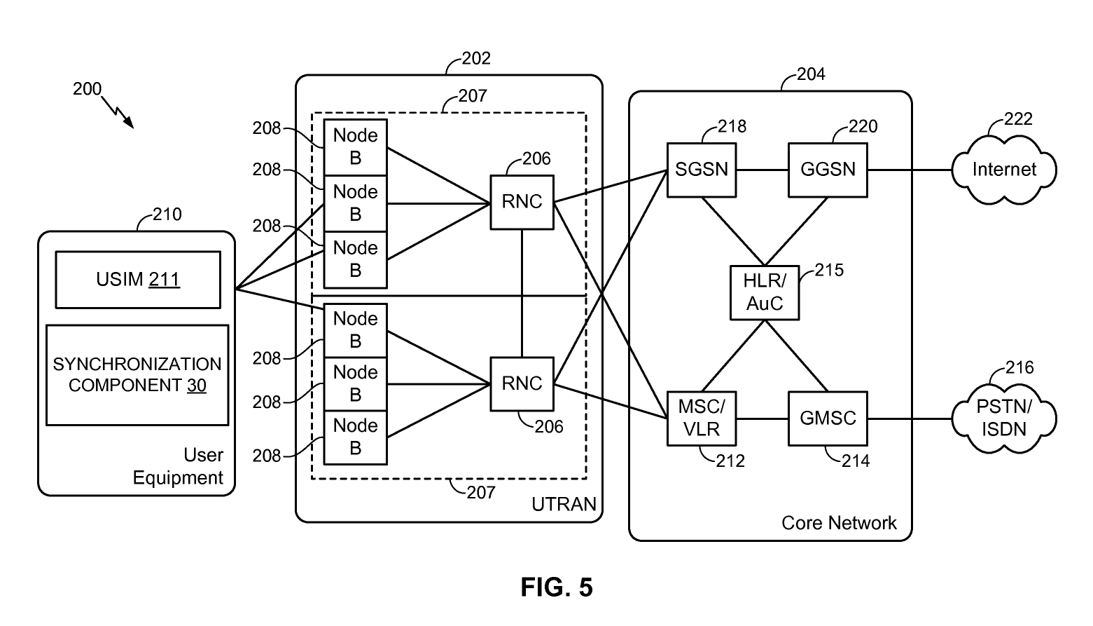

By way of example and without limitation, the aspects of the present disclosure illustrated in FIG. 5 are presented with reference to a UMTS system 200 employing a W-CDMA air interface. In this case, user equipment 210 may be the same as or similar to UE 11 of FIG. 1, and may include synchronization component 30 as described herein. A UMTS network includes three interacting domains: a Core Network (CN) 204, a UMTS Terrestrial Radio Access Network (UTRAN) 202, and User Equipment (UE) 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device.

The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW).

One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

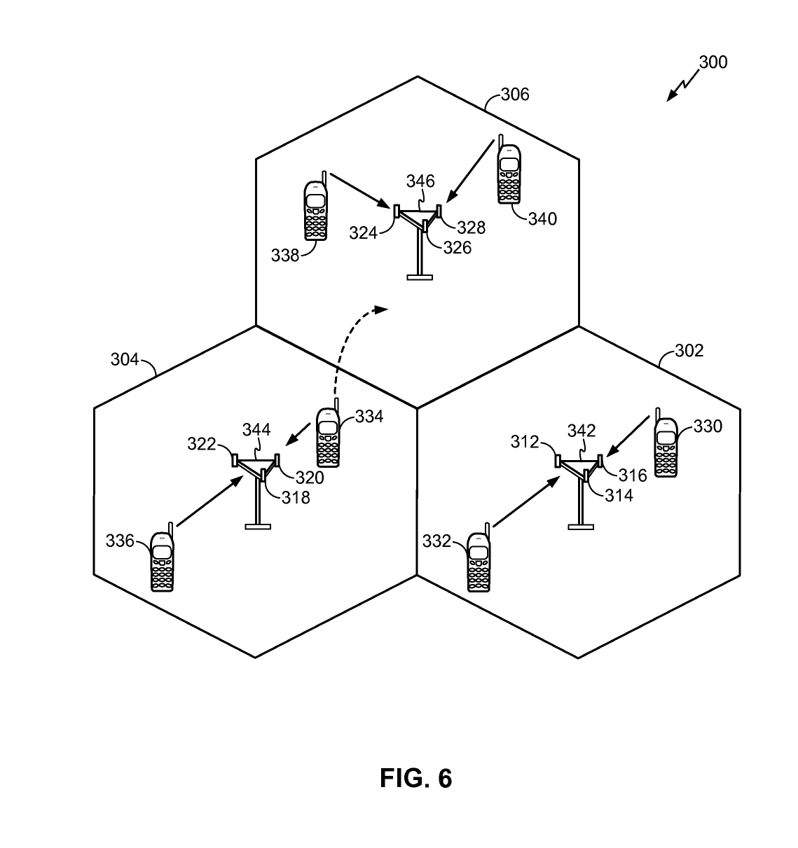

Referring to FIG. 6, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 2) for all the UEs 330, 332, 334, 336, 338, 340 in the respective cells 302, 304, and 306. UEs 330, 332, 334, 336, 338, 340 may correspond to UE 11 (FIG. 1) configured to include and/or execute synchronization component 30.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 5), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The radio protocol architecture may take on various forms depending on the particular application. An example for an HSPA system will now be presented with reference to FIG. 7.

Referring to FIG. 7 an example radio protocol architecture 400 relates to the user plane 402 and the control plane 404 of a user equipment (UE) or node B/base station. For example, architecture 400 may be included in a UE such as UE 11 (FIG. 1) configured to include and/or execute synchronization component 30. The radio protocol architecture 400 for the UE and node B is shown with three layers: Layer 1 406, Layer 2 408, and Layer 3 410. Layer 1 406 is the lowest lower and implements various physical layer signal processing functions. As such, Layer 1 406 includes the physical layer 407. Layer 2 (L2 layer) 408 is above the physical layer 407 and is responsible for the link between the UE and node B over the physical layer 407. Layer 3 (L3 layer) 410 includes a radio resource control (RRC) sublayer 415. The RRC sublayer 415 handles the control plane signaling of Layer 3 between the UE and the UTRAN.

In the user plane, the L2 layer 408 includes a media access control (MAC) sublayer 409, a radio link control (RLC) sublayer 411, and a packet data convergence protocol (PDCP) 413 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 413 provides multiplexing between different radio bearers and logical channels. The PDCP sublayer 413 also provides header compression for upper layer data packets to reduce radio transmission overhead, security by ciphering the data packets, and handover support for UEs between node Bs. The RLC sublayer 411 provides segmentation and reassembly of upper layer data packets, retransmission of lost data packets, and reordering of data packets to compensate for out-of-order reception due to hybrid automatic repeat request (HARQ). The MAC sublayer 409 provides multiplexing between logical and transport channels. The MAC sublayer 409 is also responsible for allocating the various radio resources (e.g., resource blocks) in one cell among the UEs. The MAC sublayer 409 is also responsible for HARQ operations.

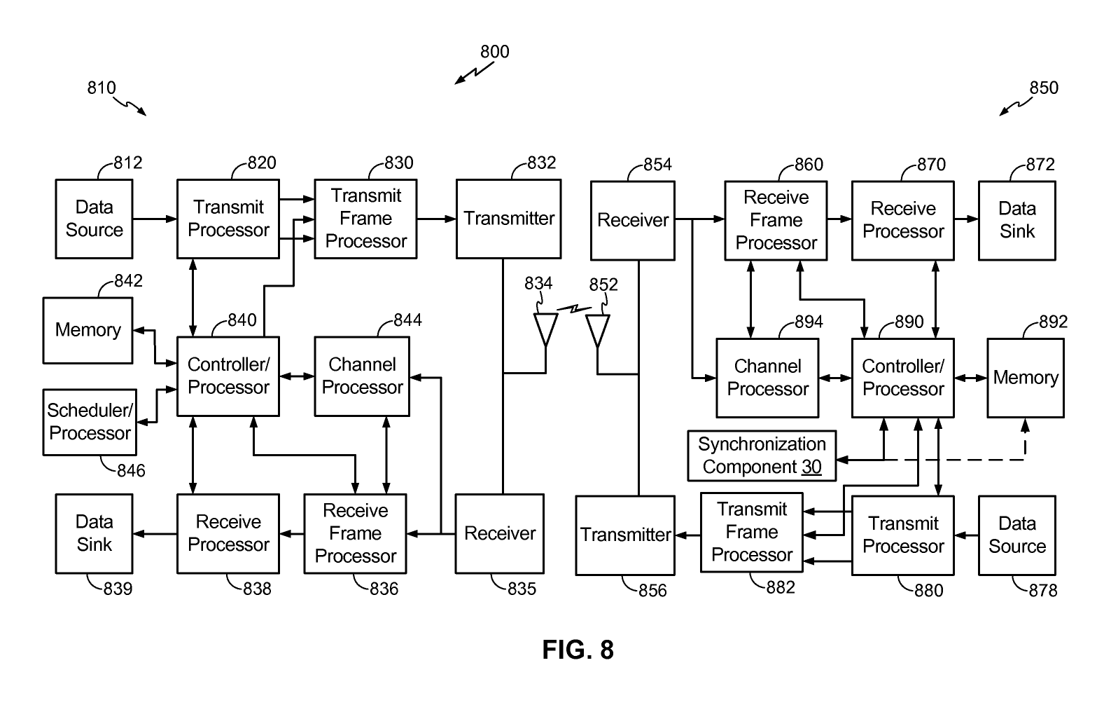

FIG. 8 is a block diagram of a Node B 810 in communication with a UE 850, where the Node B 810 may be the Node B 208 in FIG. 5, and the UE 850 may be the UE 210 in FIG. 5, or UE 11 in FIG. 1, both including the synchronization component 30 for performing the actions described herein. In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols.

Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 870. The receive processor 870 then performs the inverse of the processing performed by the transmit processor 820 in the Node B 810. More specifically, the receive processor 870 descrambles and despreads the symbols, and then determines the most likely signal constellation points transmitted by the Node B 810 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receiver processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively. A scheduler/processor 846 at the Node B 810 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of blocks or steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of synchronization in a communication network, comprising:
receiving a first status packet data unit (PDU), wherein the first status PDU is a most recent non-erroneous status PDU;
receiving a second status PDU, wherein the second status PDU is received subsequent to receiving the first status PDU;
identifying that the second status PDU includes an erroneous sequence number (SN) based at least in part on the first status PDU; and
determining whether to perform a Radio Link Control (RLC) reset based at least in part on determining that the second status PDU includes the erroneous SN.

2. The method of claim 1, wherein determining whether to perform the RLC reset includes:
determining whether the first status PDU and the second status PDU are transmitted from a same network entity in response to determining that the second status PDU includes the erroneous SN; and
performing the RLC reset based at least in part on determining that the first status PDU and the second status PDU are transmitted from the same network entity.

3. The method of claim 2, wherein determining whether the first status PDU and the second status PDU are transmitted from the same network entity is based at least in part on information obtained from the first status PDU and the second status PDU.

4. The method of claim 2, further comprising:
determining whether a first network entity and a second network entity are synchronized when the first status PDU and the second status PDU are transmitted from different network entities; and
performing the RLC reset when a determination is made that the first network entity and the second network entity are synchronized.

5. The method of claim 4, further comprising not performing the RLC reset when a determination is made that the first network entity and the second network entity are unsynchronized.

6. The method of claim 1, wherein identifying that the second status PDU includes the erroneous SN based at least in part on the first status PDU includes:
identifying a SN of the first status PDU and a SN of the second status PDU; and
determining that the SN of the second status PDU is outside a SN interval range, wherein the SN interval range is determined based at least in part on the SN of the first status PDU.

7. The method of claim 1, wherein receiving the first status PDU and the second status PDU includes receiving the first status PDU when a user equipment (UE) is configured for an inter-Node B multi-flow operation.

8. An apparatus for synchronization in a communication network, comprising:
means for receiving a first status packet data unit (PDU), wherein the first status PDU is a most recent non-erroneous status PDU;
means for receiving a second status PDU, wherein the second status PDU is received subsequent to receiving the first status PDU;
means for identifying that the second status PDU includes an erroneous sequence number (SN) based at least in part on the first status PDU; and
means for determining whether to perform a Radio Link Control (RLC) reset based at least in part on determining that the second status PDU includes the erroneous SN.

9. An apparatus for synchronization in a communication network, comprising:
a communication component configured to receive a first status packet data unit (PDU), wherein the first status PDU is the most recent non-erroneous status PDU, wherein the communication component is further configured to receive a second status PDU, wherein the second status PDU is received subsequent to receiving the first status PDU;
an identification component configured to identify that the second status PDU includes an erroneous sequence number (SN) based at least in part on the first status PDU; and
an radio link control (RLC) reset determination component configured to determine whether to perform a Radio Link Control (RLC) reset based at least in part on determining that the second status PDU includes the erroneous SN.

10. The apparatus of claim 9, wherein to determine whether to perform the RLC reset, the RLC reset determination component is further configured to:
determine whether the first status PDU and the second status PDU are transmitted from a same network entity in response to determining that the second status PDU includes the erroneous SN; and
perform the RLC reset based at least in part on determining that the first status PDU and the second status PDU are transmitted from the same network entity.

11. The apparatus of claim 10, wherein the determination of whether the first status PDU and the second status PDU are transmitted from the same network entity is based at least in part on information obtained from the first status PDU and the second status PDU.

12. The apparatus of claim 10, wherein the RLC reset determination component is further configured to:
determine whether a first network entity and a second network entity are synchronized when the first status PDU and the second status PDU are transmitted from different network entities; and
perform the RLC reset when a determination is made that the first network entity and the second network entity are synchronized.

13. The apparatus of claim 12, wherein the RLC reset determination component is further configured to not perform the RLC reset when a determination is made that the first network entity and the second network entity are unsynchronized.

14. The apparatus of claim 9, wherein to identify that the second status PDU includes the erroneous SN, the identification component is further configured to:
identify a SN of the first status PDU and a SN of the second status PDU; and
determine that the SN of the second status PDU is outside a SN interval range, wherein the SN interval range is determined based at least in part on the SN of the first status PDU.

15. The apparatus of claim 9, wherein to receive the first status PDU and the second status PDU, the communication component is further configured to receive the first status PDU when a user equipment (UE) is configured for an inter-Node B multi-flow operation.

16. A computer-readable medium storing computer executable code for synchronization in a communication network, comprising:
code executable to receive a first status packet data unit (PDU), wherein the first status PDU is the most recent non-erroneous status PDU;
code executable to receive a second status PDU, wherein the second status PDU is received subsequent to receiving the first status PDU;
code executable to identify that the second status PDU includes an erroneous sequence number (SN) based at least in part on the first status PDU; and
code executable to determine whether to perform a Radio Link Control (RLC) reset based at least in part on determining that the second status PDU includes the erroneous SN.
